(19) United States
(12) Patent Application Publication
(10) Pub. No.: US 2007/0268183 A1
(43) Pub. Date: Nov. 22, 2007

(54) OCTAGONAL MONOPOLE WITH SHORTING WIRE

(75) Inventor: Nathan Stutzke, Louisvile, CO (US)

Correspondence Address: HOLLAND & HART, LLP, P.O BOX 8749, DENVER, CO, 80201, US

(73) Assignee: Centurion Wireless Technologies, Inc., Lincoln, NE (US)

(21) Appl. No.: 11/383,583

(22) Filed: May 16, 2006

(51) Int. Cl. H01Q 1/38

(52) U.S. Cl. 343/700 MS

(57) ABSTRACT

An octagonal shaped monopole antenna is provided. The antenna includes a ground plane and a patch. The patch is generally perpendicular to and above the ground plane. A bottom edge of the patch is proximate the ground plane. A feed and short for the antenna extend from the ground plane to a side of the patch. Generally, the feed and short couple to the bottom edge of the patch.

### FIELD OF THE INVENTION

The present invention relates to a monopole antenna and, more particularly, to an octagonal shaped monopole with a shorting wire.

### BACKGROUND OF THE INVENTION

Today's wireless applications place increasing demand on bandwidth capability of an antenna structure as well as the associated size of the antenna. While the art has provided reduced profile antennas, a need remains for a reduced profile and improved bandwidth monopole style antenna.

### SUMMARY OF THE INVENTION

The present invention provides a ground plane and a patch residing generally above and perpendicular to the ground plane. A bottom edge of the ground plane is proximate but removed from the ground plane. A feed and a short for the antenna extend from the ground plane to a side of the patch, generally the side closest the ground plane.

The foregoing and other features, utilities and advantages of the invention will be apparent from the following more particular description of an embodiment of the invention as illustrated in the accompanying drawings.

### BRIEF DESCRIPTION OF THE DRAWINGS

The above and other objects and advantages of the present invention will be apparent upon consideration of the following detailed description, taken in conjunction with the accompanying drawings, in which like reference characters refer to like parts throughout, and in which:

FIG. 1 is an elevation view of an antenna consistent with an embodiment of the present invention;

FIG. 2 is a front perspective view of the antenna of FIG. 1.

### DETAILED DESCRIPTION

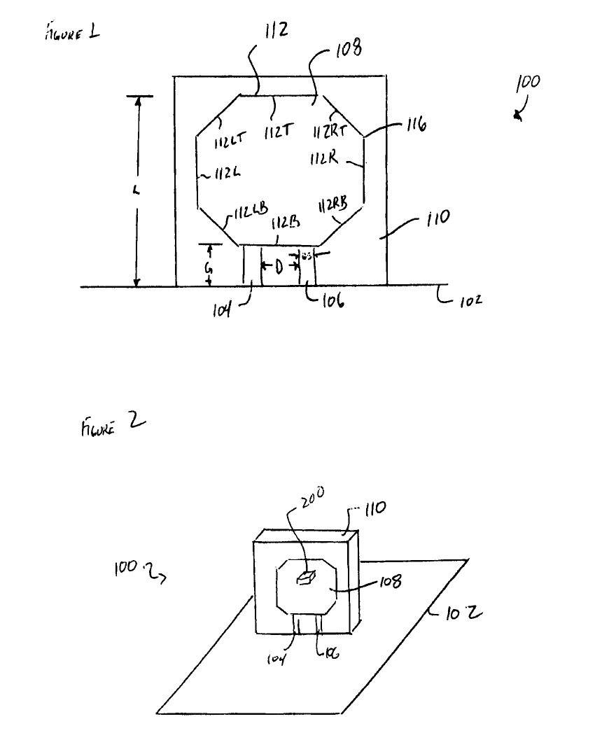

The present invention will be explained with reference to FIGS. 1 and 2. Referring first to FIG. 1, an elevation view of an antenna 100 is provided. Antenna 100 is provided above and substantially perpendicular to a ground plane 102. Generally, antenna 100 has a length L. As will be understood by one of ordinary skill in the art on reading the remainer of the disclosure, below, the length L of antenna 100 may be less than ¼ wavelength, and in some applications is less than ⅕ of the wavelength. When this feature is taken advantage of, this allows a lower profile antenna.

As shown, antenna 100 comprises a feed trace 104, a short trace 106, patch 108, and support substrate 110. Substrate 110 provides support for antenna 100 to facilitate patch 108 residing perpendicular or substantially perpendicular to ground plane 102. Substrate 110 is optional, however, and can be removed. When used, substrate 110 may be comprised of a number of materials, but it has been found using printed circuit board material is satisfactory. Moreover, increasing the dielectric constant of substrate 110 generally reduces the size of antenna 100, but also generally reduces the efficiency and bandwidth of the antenna as well.

As shown, patch 108 has eight equal length sides 112, forming a octagonal shape similar to a conventional stop sign. The junction 116 between two sides can be sharp (as shown, or curved or beveled as desired. While shown as having equal length sides 112, the sides may have differing lengths. For example, sides 112L and 112R may be significantly longer than sides 112LT, 112RT, etc. Moreover, changing the side lengths provides a tuning function for antenna 100. Bandwidth at any tuned frequency is dependent, in part, of the shape of antenna 100, which is dependent, in part, on the side lengths. While shown as having an octagonal shape, the shape of patch 108 may be any polygon shape.

Feed trace 104 and short trace 106 reside on side 112B (sometimes referred to as a bottom edge) closest to ground plane 102. Either or both of feed trace 104 and short trace 106 may be connected to other sides, such as, for example, short trace 106 may connect to side 112RB or 112R. The length of feed trace 104 and/or short trace 106 provides a tuning feature. Moreover, a longer short trace 106 generally reduces the resonant frequency of antenna 100. A gap G exists between side 112B and ground plane 102. Gap G is somewhat dependent on the tuned resonant frequency.

Feed trace 104 and short trace 106 are separated by a distance D. Varying distance D provides impedance matching making it unnecessary to have a separate matching circuit. However, a matching circuit may be used.

Short trace 106 is useful in tuning antenna 100. Varying the a width WS of short trace 106 allows the operating frequency of antenna 100 to be tuned.

While not shown, antenna 100 may have a slot. The slot tends to lower the resonant frequency, although it is believed the slot would have to extend/terminate on a side. Also, parasitic elements, such as parasitic element 200 (shown only in FIG. 2) may be use to tune antenna 100. Parasitic element 200 is shown extending perpendicular patch 108. Also, patch 108 is shown generally perpendicular to ground plane 102. Patch 108 may be angled as desired.

While the invention has been particularly shown and described with reference to one or more embodiments thereof, it will be understood by those skilled in the art that various other changes in the form and details may be made without departing from the spirit and scope of the invention.

I claim:

1. An antenna, comprising:
a ground plane;
a patch is substantially perpendicular to the ground plane have a bottom edge;
a feed extending between the ground plane and the bottom edge of the patch to provide radio frequency power to the patch; and
a short located a distance from the feed and extending between the ground plane and the bottom edge of the patch to provide a short, wherein
the operating frequency of the antenna is partially controlled by the short.

2. The antenna according to claim 1, wherein the patch comprises an octagonal shape.

3. The antenna according to claim 1, wherein a gap exists between the bottom edge and the ground plane.

4. The antenna according to claim 3, wherein the antenna comprises a length.

5. The antenna according to claim 1, wherein the length is less than ¼ wavelength.

6. The antenna according to claim 1, wherein the patch has a plurality of sides joined by junctions.

7. The antenna according to claim 6, wherein the junctions are curved.

8. The antenna according to claim 1, wherein the patch resides on a substrate.

9. The antenna according to claim 8, wherein the substrate comprises a printed circuit board.

10. The antenna according to claim 1, wherein the patch is perpendicular to the ground plane.

11. The antenna according to claim 1, wherein the patch is angled to the ground plane.

12. The antenna according to claim 1, further comprising at least one parasitic element coupled to the patch.

13. An antenna, comprising:
a ground plane;
a patch, the patch forming an angle with respect to the ground plane, the patch having a plurality of sides;
the plurality of sides including at least a bottom side, a top side, a left side and a right side;
a feed having a feed length extending between the ground plane and at least a first one of the plurality of sides to provide radio frequency power to the patch; and
a short having a short length located a distance from the feed and extending between the ground plane and at least a second one of the plurality of sides;
the operating frequency of the antenna is partially controlled by the distance and the short length.

14. The antenna according to claim 13, wherein the angle is 90 degrees.

15. The antenna according to claim 13, wherein the first one of the plurality of sides and the second one of the plurality of sides are the same side.

16. The antenna according to claim 13, further comprising a matching network.

17. The antenna according to claim 13, further comprising a substrate, the patch resides on the substrate.

18. The antenna according to claim 17, wherein the substrate comprises a printed circuit board.

19. The antenna according to claim 13, wherein the patch comprises an octagonal shape.

20. The antenna according to claim 13, wherein the patch comprises a shape selected from the group of shapes consisting of polygons.
